(19) United States
(12) Patent Application Publication
(10) Pub. No.: US 2025/0222993 A1
(43) Pub. Date: Jul. 10, 2025

(54) ACTIVE AIR SKIRT DEVICE

(71) Applicant: HYUNDAI MOBIS CO., LTD., Seoul (KR)

(72) Inventors: Jae Sup BYUN, Yongin-si (KR); Jang Ho KIM, Yongin-si (KR)

(73) Assignee: HYUNDAI MOBIS CO., LTD., Seoul (KR)

(21) Appl. No.: 18/814,042

(22) Filed: Aug. 23, 2024

(30) Foreign Application Priority Data
Jan. 9, 2024 (KR) 10-2024-0003593

(51) Int. Cl. B62D 35/00

(52) U.S. Cl. CPC B62D 35/00

(57) ABSTRACT

An active air skirt device including a housing including a through hole and a guide hole formed therein, a bracket configured to mount the housing to a bumper cover, an air skirt installed inside the housing and configured to reciprocate back and forth through an open front of the housing, an actuator coupled to the housing, the actuator configured to generate power, and a connecting link configured to connect the actuator and the air skirt and transmit the power of the actuator to the air skirt, the housing being arranged obliquely toward a lower part of the bumper cover to deploy the air skirt obliquely forward under the lower part of the bumper cover.

### CROSS REFERENCE TO RELATED APPLICATION

The present application claims the benefit under 35 USC § 119(a) of Korean Patent Application No. 10-2024-0003593, filed on Jan. 9, 2024, in the Korean Intellectual Property Office, the entire disclosure of which is incorporated herein by reference in its entirety for all purposes.

### BACKGROUND OF THE INVENTION

### 1. Field of the Invention

The present invention relates to an active air skirt device for vehicles.

### 2. Description of the Related Art

Vehicles experience air resistance due to the collision of their bodies with the air during driving, which can be broadly categorized into drag and lift. Drag is the opposing force acting on the vehicle due to direct air collision during motion, while lift is the phenomenon where the vehicle appears to rise due to the pressure difference between the upper and lower surfaces of the vehicle during movement. To reduce drag and lift, and thereby improve aerodynamic performance and fuel efficiency, vehicles require attachments.

One such device is the active air skirt, which operates in conjunction with vehicle speed to reduce lift by minimizing the amount of air entering the underbody through the front bumper during high-speed driving, thereby enhancing aerodynamic performance.

Conventional active air skirts, however, have limitations in that they operate only in the vertical direction, resulting in less effective air blockage at the lower front of the bumper cover. Therefore, there is a need for improvement.

### SUMMARY

In a general aspect, here is provided an active air skirt device including a housing including a through hole and a guide hole formed therein, a bracket configured to mount the housing to a bumper cover, an air skirt installed inside the housing and configured to reciprocate back and forth through an open front of the housing, an actuator coupled to the housing, the actuator configured to generate power, and a connecting link configured to connect the actuator and the air skirt and transmit the power of the actuator to the air skirt, the housing being arranged obliquely toward a lower part of the bumper cover to deploy the air skirt obliquely forward under the lower part of the bumper cover.

The bracket may include a first part extending vertically at a rear of the bumper cover and a second part bent at a lower end of the first part, extending obliquely forward under the lower part of the bumper cover, and the housing may be coupled to the second part.

The second part may include a coupling recess defined therein in which the housing is coupled.

The connecting link may include a first link connected at one end to the actuator and a second link rotatably connected at a first end to an other end of the first link and connected at a second end to the air skirt, and the connecting link maybe arranged on an upper surface of the housing and connected to the air skirt through the housing.

The guide hole may include a slot-shaped structure extending linearly towards the open front of the housing, the slot-shaped structure being configured to accommodate a connecting axis of the second link connected with the air skirt to reciprocate along the guide hole.

The active air skirt device may include a stopper provided on the upper surface of the housing, the stopped being configured to limit a rotation range of the first link, the stopper being formed by protruding in a structure partially surrounding the through hole into which a rotation axis of the first link is inserted.

The active air skirt device may include a housing cover attached to the upper surface of the housing to cover and seal the connecting link.

The air skirt may include a main body, a pair of guide portions extending parallel from both sides of the main body, and a connecting portion extending from a center of the main body, the main body being deployed to the open front of the housing under the bumper cover and the air skirt may be extended in a forward direction from the housing.

The pair of guide portions may each include a guide groove defined therein and configured to engage with guide protrusions provided inside the housing.

The connecting portion may be arranged parallel between the guide portions, and the connecting portion may be configured to be connected to the connecting link.

In a general aspect, here is provided a vehicle including a bumper cover and an active air skirt device, the air skirt device including an air skirt installed inside the housing and configured to reciprocate back and forth responsive to a motion of an actuator and a housing configured to extend obliquely toward a lower part of the bumper cover to deploy the air skirt obliquely forward under the lower part of the bumper cover, the housing including a through hole and a guide hole formed therein through which the air skirt reciprocates back and forth.

The vehicle may further include a connecting link configured to connect the actuator and the air skirt and transmit the power of the actuator to the air skirt.

The active air skirt device may also include a main body, a pair of guide portions extending parallel from both sides of the main body, and a connecting portion extending from a center of the main body.

The main body may be deployed to the open front of the housing under the bumper cover.

The air skirt may be extended in a forward direction from the housing.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a schematic diagram illustrating an active air skirt device according to an embodiment of the present invention;

FIG. 2 is a diagram illustrating the operation of the active air skirt device;

FIG. 3 is an exploded perspective view illustrating the configuration of the active device;

FIG. 4 is a diagram illustrating the bracket in the active air skirt device;

FIGS. 5A and 5B are diagrams each illustrating the housing in the active air skirt device;

FIG. 6 is a diagram illustrating the air skirt in the active air skirt device; and

FIG. 7 is a diagram illustrating the connecting link in the active air skirt device.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

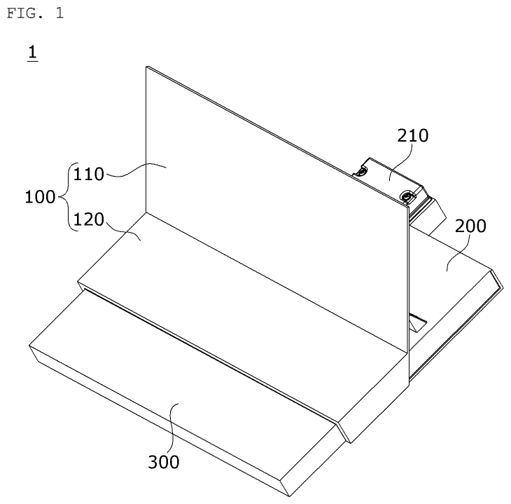

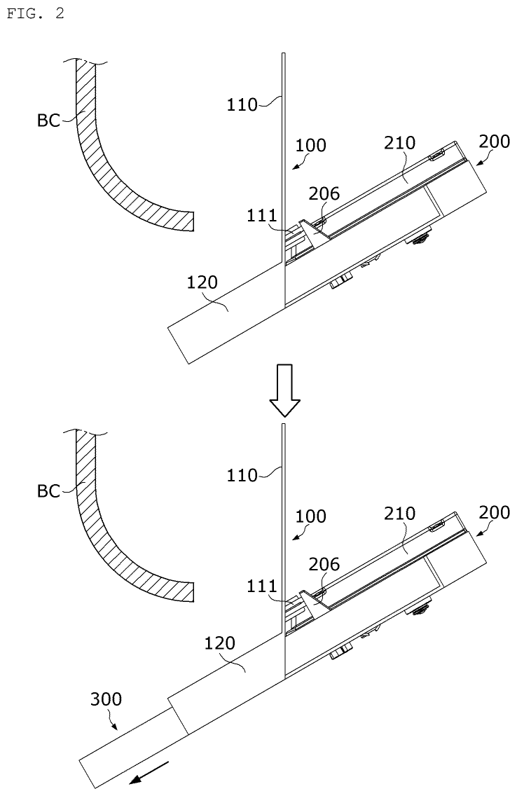

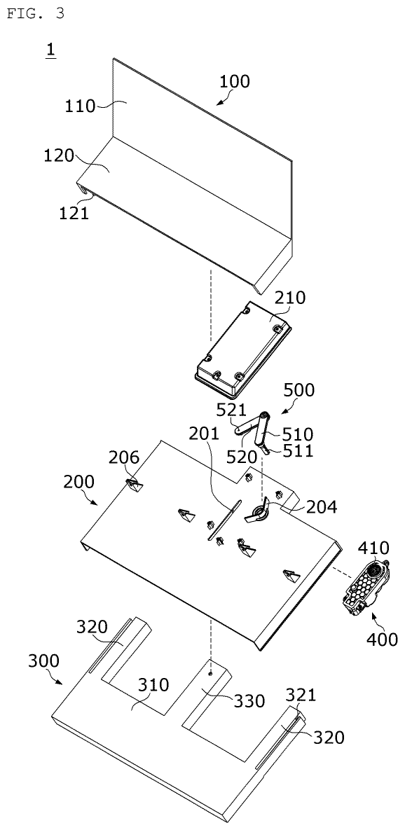

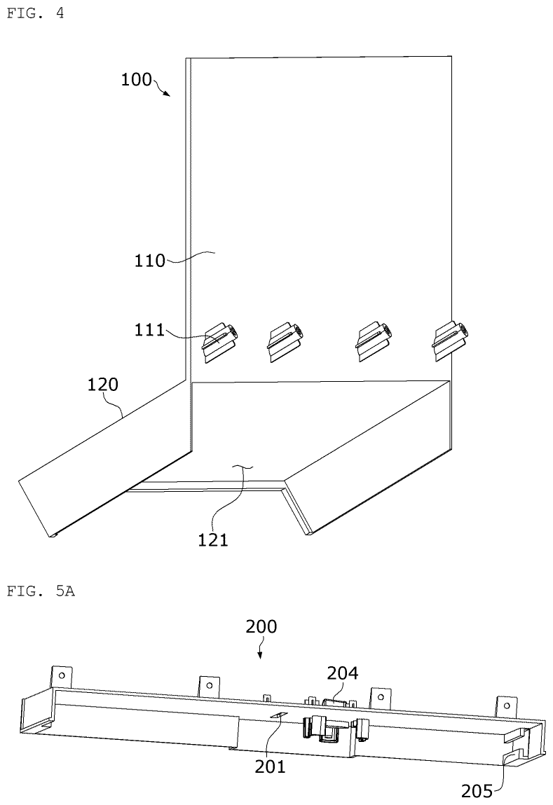

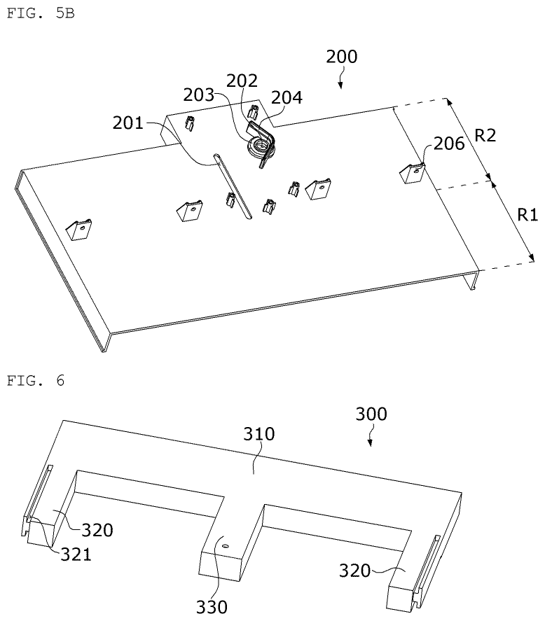

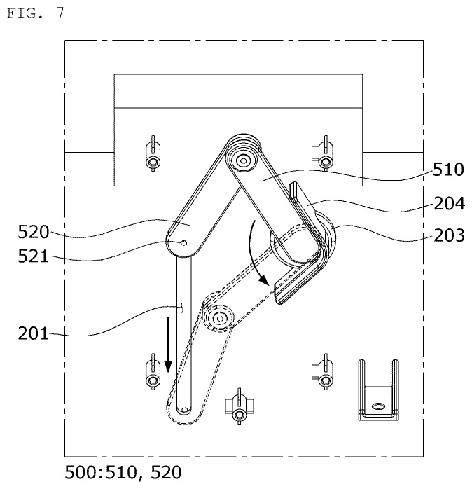

FIGS. 1 to 7 illustrate the active air skirt device 1 according to an embodiment of the present invention.

With reference to the drawings, the active air skirt device 1 according to an embodiment of the present invention may include a bracket 100, a housing 200, an air skirt 300, an actuator 400, and a connecting link 500.

The bracket 100 may be configured to mount the housing 200 onto the bumper cover BC. The bracket 100 may include a first part 110 and a second part 120.

The first part 110 may extend vertically from the rear of the bumper cover BC. The first part 110 may be coupled and fixed to a back beam (not shown) at the rear or the backside of the bumper cover BC.

The first part 110 may be provided, on the rear surface thereof, with attachment protrusions 111 for fastening with the housing 200. The attachment protrusions 111 may be arranged in plurality at a predetermined interval along the width direction of the first part 110.

The second part 120 may be bent at the lower end of the first part 110 and extend obliquely forward under the bottom of the bumper cover BC. The diagonal inclination of the second part 120 may be variously adjusted according to the shape of the bumper cover BC, the distance to the ground, and the gap to the front of the bumper cover BC. The second part 120 may be provided with a coupling recess 121 to which the housing 200 is coupled.

The housing 200 may have an internal space and be coupled to the bracket 100 to be mounted on the bumper cover BC. In an embodiment, the housing 200 may be fitted into the coupling recess 121 of the second part 120.

The housing 200 may have a structure with the front and bottom open. Although illustrated as having the bottom open in this embodiment, the housing 200 may have a structure with only the front open depending on the embodiment.

In an embodiment, the housing 200 may be divided into a front region R1 and a rear region R2 based on the front-to-rear direction. The front region R1 corresponds to the area fitting into the coupling recess 121 of the second part 120, while the rear region R2 may correspond to the area angled with the first part 110 and positioned at the rear of the second part 120.

The housing 200 may be provided, on the upper surface thereof, with a guide hole 201 formed extending linearly towards the front. The guide hole 201 may have a slotted structure cut longitudinally, penetrating through the upper surface of the housing 200. In an embodiment, the guide hole 201 may be positioned in the rear region R2 of the housing 200.

On the upper surface of the housing 200, a through hole 202 may be formed to expose the drive shaft 410 of the actuator 400. Additionally, a projection 203 forming a step with the upper surface may be provided around the circumference of the through hole 202.

The housing 200 may also be provided, on the upper surface thereof, with a stopper 204 limiting the rotational range of the connecting link 500, as described later. The stopper 204 may be formed by protruding, as a structure partially surrounding the through hole 202, from one side of the projection 203. For example, the stopper 204 may be formed as a structure extending to a predetermined angular range (acute or obtuse). In this case, the height of the stopper 204 may be higher than that of the projection 203.

A housing cover 210 may be attached to the upper surface of the housing 200, partially covering the rear region R2 that includes the guide hole 201 and the stopper 204. The housing cover 210 may be designed to cover and seal the connecting link 500 on the upper surface of the housing 200, protecting the connecting link 500 from the external environment.

On the upper surface of the housing 200, coupling ribs 206 may be formed protruding to be coupled to the attachment protrusions 111 via coupling means. The coupling ribs 206 may be provided corresponding to the positions and quantities of the attachment protrusions 111. In an embodiment, the coupling means may include screws or bolts.

The housing 200 may be provided with guide protrusions 205 extending from the rear region R2 to the front region R1 along the inner surface.

The air skirt 300 may be installed inside the housing 200 to allow forward and backward reciprocating movement through the open front of the housing 200.

The air skirt 300 may include a main body 310, a pair of guide portions 320 extending parallel from both sides of the main body 310, and a connecting portion 330 extending from the center of the main body 310.

When the air skirt 300 is retracted inside the housing 200, the main body 310 is positioned in the front region R1 of the housing 200, and the guide portions 320 and the connecting portion 330 are positioned in the rear region R2. When the air skirt 300 is extended forward from the housing 200, the main body 310 may be deployed to the front below the bumper cover BC, and the guide portions 320 and the connecting portion 330 may be positioned in the front region R1.

Each of the paired guide portions 320 may be provided with a guide groove 321 that engages with the guide protrusions 205 provided inside the housing 200. The guide groove 321 may be provided as a structure extending longitudinally along the length direction of the guide portion 320. The pair of guide portions 320 may guide the forward and backward reciprocating movement of the main body 310 with the guide grooves 321 and guide protrusions 205 engaged.

The connecting portion 330 may be arranged between the pair of guide portions 320 and extend parallel to the guide portions 320. The connecting portion 330 may be connected to the connecting link 500 to be described later.

The actuator 400, coupled to the housing 200, may generate power to drive the air skirt 300 to be described later.

In an embodiment, the actuator 400 may be arranged inside the housing 200 in the rear region R2 of the housing 200. The drive shaft 410 of the actuator 400 may be exposed through the through hole 202.

The connecting link 500 may connect the actuator 400 to the air skirt 300, transmitting power from the actuator 400 to drive the air skirt 300.

The connecting link 500 may include a first link 510 and a second link 520 connected for mutual rotation.

The first link 510 is connected at one end to the actuator 400 and at the other end to one end of the second link 520. The second link 520, which is rotatably connected at one end to the other end of the first link 510, may be connected at the other end to the connecting portion 330 of the air skirt 300.

In an embodiment, the connecting link 500 may be arranged on the upper surface of the housing 200. The connecting link may be connected to the actuator 400 and the air skirt 300 by penetrating the housing 200.

In detail, the first link 510 may be connected to the actuator 400 by inserting a rotation axis 511 into the through hole 202 formed by penetrating the upper surface of the housing 200. In this case, the rotation axis 511 may be inserted into the through hole 202 while the first link 510 is placed on the projection 203. The second link 520 may be connected to the connecting portion 330 of the air skirt 300 by inserting a connection axis 521 into the guide hole 201 formed in the housing 200. The connection axis 521 of the second link 520 may reciprocate along the guide hole 201 while connected to the air skirt 300.

The first link 510 may be rotated about the rotation axis 511, while spaced apart from the upper surface of the housing 200 by the height of the projection 203. Here, the rotation range of the first link 510 may be limited by the stopper 204. That is, the first link 510 may rotate within the angular range provided by the stopper 204. The second link 520 may reciprocate along the length of the guide hole 201 in linkage with the first link 510.

The first link 510 and the second link 520 may be sealed by the housing cover 210 to be protected from the outside.

According to an embodiment of the present invention, the housing 200 is obliquely arranged in a downward direction towards the lower part of the bumper cover BC, and the air skirt 300 is configured to be deployed in a forward direction under the lower part of the bumper cover BC in an oblique direction, thereby enabling the lower space of the bumper cover BC to be blocked at the same level as the front portion of the bumper cover BC. As a result, the effect of blocking air from the front surface of the bumper cover BC is increased, hereby more effectively improving aerodynamic performance.

In addition, by blocking the lower space of the bumper cover BC with the deployed air skirt 300 at the same level as the front surface of the bumper cover BC, it effectively prevents pedestrians' lower legs from bending into the lower space of the bumper cover BC in the event of a pedestrian collision, thereby more effectively protecting pedestrians.

The active air skirt device according to an embodiment of the present invention is advantageous in terms of effectively improving the aerodynamic performance of a vehicle.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An active air skirt device, comprising:
a housing including a through hole and a guide hole formed therein;
a bracket configured to mount the housing to a bumper cover;
an air skirt installed inside the housing and configured to reciprocate back and forth through an open front of the housing;
an actuator coupled to the housing, the actuator configured to generate power; and
a connecting link configured to connect the actuator and the air skirt and transmit the power of the actuator to the air skirt,
wherein the housing is arranged obliquely toward a lower part of the bumper cover to deploy the air skirt obliquely forward under the lower part of the bumper cover.

2. The active air skirt device of claim 1, wherein the bracket comprises:
a first part extending vertically at a rear of the bumper cover; and
a second part bent at a lower end of the first part, extending obliquely forward under the lower part of the bumper cover, and
wherein the housing is coupled to the second part.

3. The active air skirt device of claim 2, wherein the second part includes a coupling recess defined therein in which the housing is coupled.

4. The active air skirt device of claim 1, wherein the connecting link comprises:
a first link connected at one end to the actuator; and
a second link rotatably connected at a first end to an other end of the first link and connected at a second end to the air skirt, and
wherein the connecting link is arranged on an upper surface of the housing and connected to the air skirt through the housing.

5. The active air skirt device of claim 4, wherein the guide hole comprises a slot-shaped structure extending linearly towards the open front of the housing, the slot-shaped structure being configured to accommodate a connecting axis of the second link connected with the air skirt to reciprocate along the guide hole.

6. The active air skirt device of claim 4, further comprising:
a stopper provided on the upper surface of the housing, the stopped being configured to limit a rotation range of the first link,
wherein the stopper is formed by protruding in a structure partially surrounding the through hole into which a rotation axis of the first link is inserted.

7. The active air skirt device of claim 4, further comprising:
a housing cover attached to the upper surface of the housing to cover and seal the connecting link.

8. The active air skirt device of claim 1, wherein the air skirt comprises:
a main body;
a pair of guide portions extending parallel from both sides of the main body; and
a connecting portion extending from a center of the main body,
wherein the main body is deployed to the open front of the housing under the bumper cover, and
wherein the air skirt is extended in a forward direction from the housing.

9. The active air skirt device of claim 8, wherein the pair of guide portions each comprise:
a guide groove defined therein and configured to engage with guide protrusions provided inside the housing.

10. The active air skirt device of claim 8, wherein the connecting portion is arranged parallel between the guide portions, the connecting portion being configured to be connected to the connecting link.

11. A vehicle, comprising:
a bumper cover; and
an active air skirt device, the air skirt device comprising:
an air skirt installed inside the housing and configured to reciprocate back and forth responsive to a motion of an actuator; and
a housing configured to extend obliquely toward a lower part of the bumper cover to deploy the air skirt obliquely forward under the lower part of the bumper cover, the housing including a through hole and a guide hole formed therein through which the air skirt reciprocates back and forth.

12. The vehicle of claim 11, further comprising:
a connecting link configured to connect the actuator and the air skirt and transmit the power of the actuator to the air skirt.

13. The vehicle of claim 11, wherein the active air skirt device comprises:
a main body;
a pair of guide portions extending parallel from both sides of the main body; and
a connecting portion extending from a center of the main body.

14. The vehicle of claim 13, wherein the main body is deployed to the open front of the housing under the bumper cover.

15. The vehicle of claim 13, wherein the air skirt is extended in a forward direction from the housing.
